(19) United States
(12) Patent Application Publication
(10) Pub. No.: US 2024/0303714 A1
(43) Pub. Date: Sep. 12, 2024

(54) METHOD AND SYSTEM FOR GENERATING SUPPLY RECOMMENDATIONS

(71) Applicant: Dell Products L.P., Round Rock, TX (US)

(72) Inventors: Indranil Chakraborty, Bangalore (IN); Madan Kumar Manjunath, Singapore (SG); Vignesh Sundararaj, Guelph (CA); Madhura Ganguly, Singapore (SG); James Chen, Taipei City (TW)

(21) Appl. No.: 18/180,475

(22) Filed: Mar. 8, 2023

(51) Int. Cl. G06Q 30/0601

(52) U.S. Cl. CPC G06Q 30/0631

(57) ABSTRACT

Techniques described herein relate to a method for generating supply recommendations. The method includes identifying, by a supply recommendation engine, a recommendation generation event associated with a part; in response to identifying the recommendation generation event: obtaining part information associated with the recommendation generation event; obtaining a first constraint configuration; and generating a first recommendation based on the first constraint configuration and the part information; obtaining a second constraint configuration; in response to obtaining the second constraint configuration; generating a second recommendation based on the second constraint configuration and the part information; and performing supply actions based on the first optimization recommendations and the second optimization recommendations.

### BACKGROUND

Computing devices may provide services for users. To provide the services, the computing devices may generate data. The computing devices may provide and obtain data from other computing devices. The data may be used to generate recommendations. Recommendations may be generated using a model.

### SUMMARY

In general, certain embodiments described herein relate to a method for generating supply recommendations. The method may include identifying, by a supply recommendation engine, a recommendation generation event associated with a part; in response to identifying the recommendation generation event: obtaining part information associated with the recommendation generation event; obtaining a first constraint configuration; and generating a first recommendation based on the first constraint configuration and the part information; obtaining a second constraint configuration; in response to obtaining the second constraint configuration; generating a second recommendation based on the second constraint configuration and the part information; and performing supply actions based on the first optimization recommendations and the second optimization recommendations.

In general, certain embodiments described herein relate to a system for performing data protection of file system data on a host. The system includes a storage for storing recommendations. The system also includes a supply recommendation engine that includes a processor and memory and is programmed to identify a recommendation generation event associated with a part; in response to identifying the recommendation generation event: obtain part information associated with the recommendation generation event; obtain a first constraint configuration; and generate a first recommendation based on the first constraint configuration and the part information; obtain a second constraint configuration; in response to obtaining the second constraint configuration; generate a second recommendation based on the second constraint configuration and the part information; and perform supply actions based on the first optimization recommendations and the second optimization recommendations.

In general, certain embodiments described herein relate to a non-transitory computer readable medium that includes computer readable program code, which when executed by a computer processor enables the computer processor to perform a method for generating supply recommendations. The method may include identifying, by a supply recommendation engine, a recommendation generation event associated with a part; in response to identifying the recommendation generation event: obtaining part information associated with the recommendation generation event; obtaining a first constraint configuration; and generating a first recommendation based on the first constraint configuration and the part information; obtaining a second constraint configuration; in response to obtaining the second constraint configuration; generating a second recommendation based on the second constraint configuration and the part information; and performing supply actions based on the first optimization recommendations and the second optimization recommendations.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments disclosed herein.

FIG. 1B shows a diagram of a supply recommendation engine in accordance with one or more embodiments disclosed herein.

FIG. 2A shows a flowchart of a method for performing supply recommendation services in accordance with one or more embodiments disclosed herein.

FIG. 2B shows a flowchart of a method for generating recommendations in accordance with one or more embodiments disclosed herein.

FIG. 3 shows a diagram of a computing device in accordance with one or more embodiments disclosed herein.

### DETAILED DESCRIPTION

Specific embodiments will now be described with reference to the accompanying figures. In the following description, numerous details are set forth as examples of the embodiments disclosed herein. It will be understood by those skilled in the art that one or more embodiments disclosed herein may be practiced without these specific details and that numerous variations or modifications may be possible without departing from the scope of the embodiments disclosed herein. Certain details known to those of ordinary skill in the art are omitted to avoid obscuring the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to methods, systems, and non-transitory computer readable mediums for performing supply recommendation generation services.

Cost effective supplier selection and order allocation is a well-known and crucial aspect of procurement planning for multi-sourced commodities for companies. Cost effective supplier selection and order allocation may not only directly impact production costs but may also influence production lead times and, in turn, customer satisfaction. With a myriad of factors such as product demand, part quality, purchasing price and buyer-supplier relationship influencing buyer's decision making, optimally determining order quantity sourced from each supplier for each part may be extremely challenging. Embodiments disclosed herein address, at least in part, the supplier selection and order allocation problem for multi-sourced commodities in a user's supply chain organization. Embodiments disclosed herein relate to using a supply recommendation engine to determine a recommendation of the sourcing quantity for each part from each supplier by minimizing total purchasing cost while satisfying multiple constraints that mirror traditional part procurement methods.

Embodiments of the invention may alleviate the problem of optimal supplier and order quantity allocation by providing a system that goes from raw data to supply recommendations without needing significant manual intervention while providing significant flexibility. The supply recommendation engine may include a linear optimization algorithm. First, the supply recommendation engine may process data from disparate sources to produce a consolidated data source that makes it easier for itself and users to refer to historical data. As a result, users may not be required to manually manage and update data, and the supply recommendation engine may mitigate the risk of human errors committed while doing so. The processed data may then get fed into the supply recommendation engine controller that runs the optimization model. The optimization model may be programmed to, or otherwise adapted to, minimize total procurement cost across all parts being procured while satisfying required constraints and produce recommendations for optimal allocation of part orders to suppliers. The supply recommendation engine may generate or otherwise use a user interface that provides the flexibility to adjust constraints and simulate different business scenarios. Embodiments disclosed herein may be seamlessly integrated with a quarterly commodity procurement planning process or other time period based procurement planning process, and would enable users (e.g., product procurement managers) to be more productive, saving valuable time that currently goes into doing manual analysis and optimization. As a result, the efficiency, cost, and accuracy of product procurement may be greatly improved.

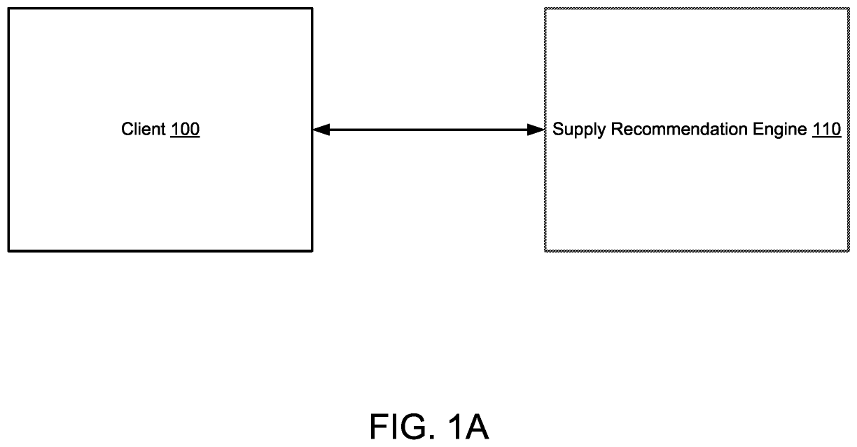

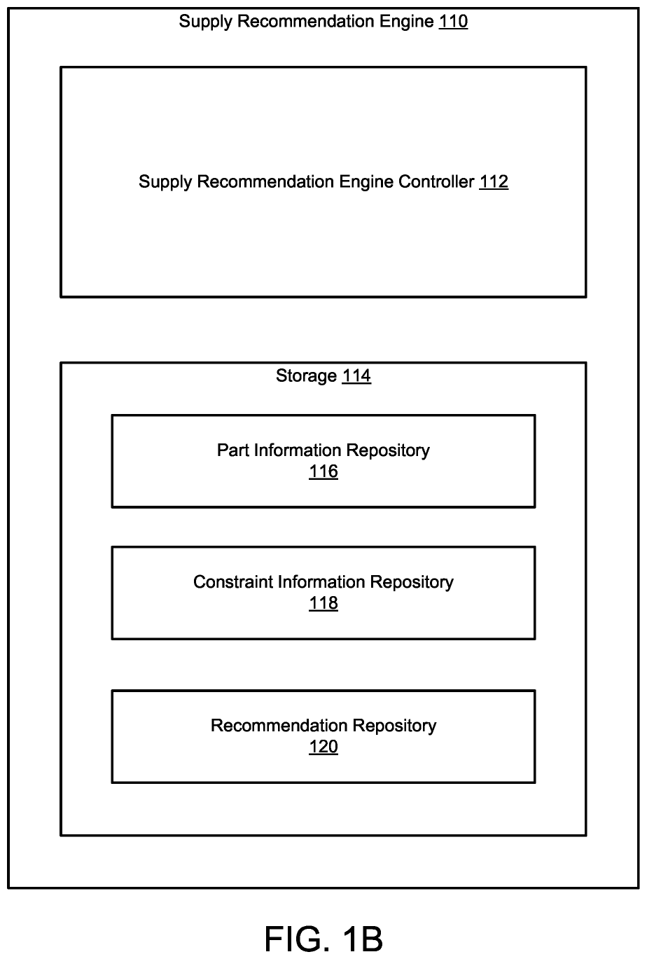

FIG. 1A shows a diagram a system in accordance with one or more embodiments disclosed herein. The system may include a client (100 and a supply recommendation engine (110). The components of the system illustrated in FIG. 1A may be operatively connected to each other and/or operatively connected to other entities (not shown) via any combination of wired (e.g., Ethernet) and/or wireless networks (e.g., local area network, wide area network, Internet, etc.) without departing from embodiments disclosed herein. Each component of the system illustrated in FIG. 1A is discussed below.

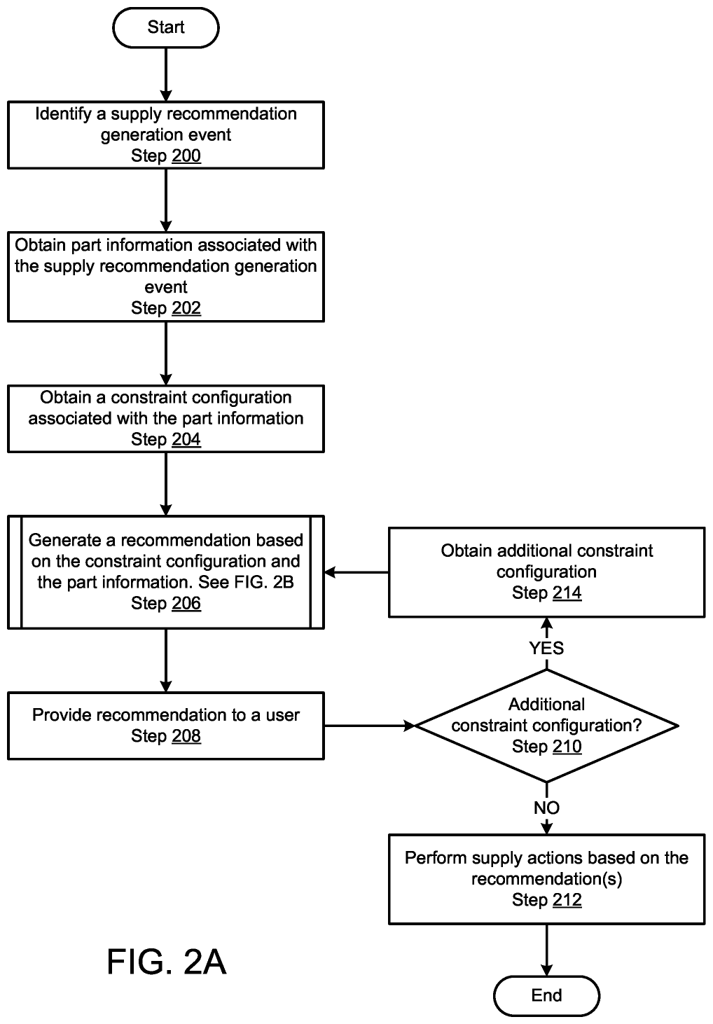

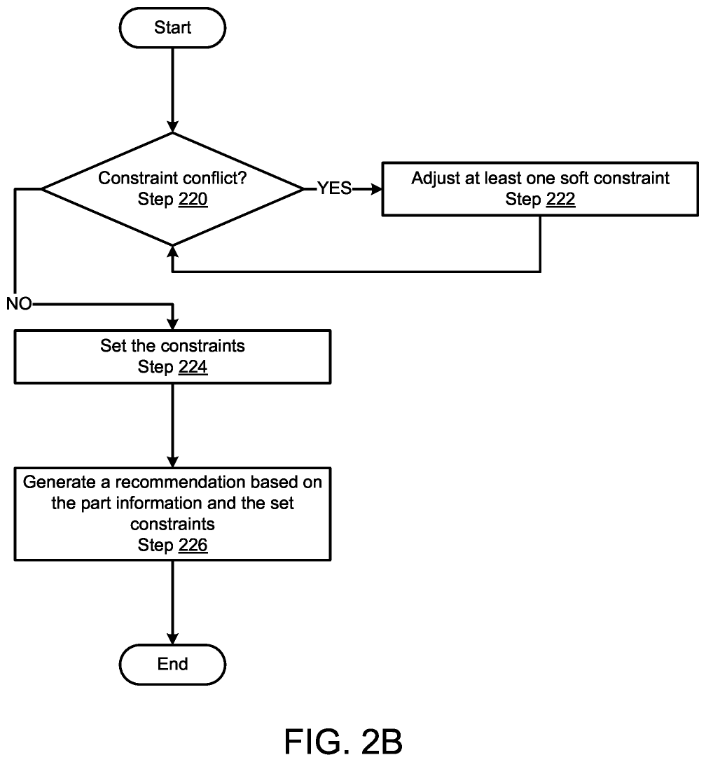

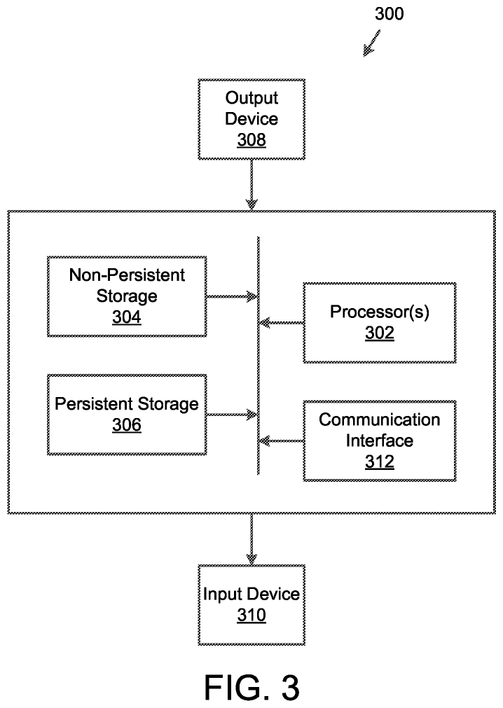

In one or more embodiments, the client (100) may be implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions of the client (100) described herein and/or all, or a portion, of the methods illustrated in FIGS. 2A-2B. The client (100) may be implemented using other types of computing devices without departing from the embodiments disclosed herein. For additional details regarding computing devices, refer to FIG. 3.

The client (100) may be implemented using logical devices without departing from the embodiments disclosed herein. For example, the client (100) may include virtual machines that utilize computing resources of any number of physical computing devices to provide the functionality of the client (100). The client (100) may be implemented using other types of logical devices without departing from the embodiments disclosed herein.

In one or more embodiments, the client (100) may include the functionality to, or otherwise be programmed or configured to, obtain supply recommendation services for users of the client (100). To obtain the supply recommendation services, the client (100) may include the functionality to send and/or receive information or requests to or from the supply recommendation engine (110). The client (100) may include the functionality to perform all, or a portion of, the methods discussed in FIGS. 2A-2B. The client (100) may include other and/or additional functionalities without departing from embodiments disclosed herein. For additional information regarding the functionality of the client (100), refer to FIGS. 2A-2B.

In one or more embodiments, the supply recommendation engine (110) may be implemented using one or more computing devices. A computing device may be, for example, mobile phones, tablet computers, laptop computers, desktop computers, servers, or cloud resources. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described herein and/or all, or a portion, of the methods illustrated in FIGS. 2A-2B. The supply recommendation engine (110) may be implemented using other types of computing devices without departing from embodiments disclosed herein. For additional details regarding computing devices, refer to FIG. 3.

In one or more embodiments, the supply recommendation engine (110) may be implemented using logical devices without departing from embodiments disclosed herein. For example, the supply recommendation engine (110) may include virtual machines that utilize computing resources of any number of physical computing devices to provide the functionality of the supply recommendation engine (110). The supply recommendation engine (110) may be implemented using other types of logical devices without departing from the embodiments disclosed herein.

In one or more embodiments, the supply recommendation engine (110) may include the functionality to, or may be otherwise programmed or configured to, perform supply recommendation services for the user of the client (100). The supply recommendation services may include: (i) obtaining and/or collating part information from multiple sources (not shown in FIG. 1A), (ii) enabling a user to provide recommendation requests and constraint configurations, (iii) generating supply recommendations based on the part information and one or more constraint configurations, and (iv) a providing the user with a comprehensive view of the supply recommendations for multiple constraint configurations. The supply recommendation services may include other and/or additional services without departing from embodiments disclosed herein. The supply recommendation engine (110) may include other and/or additional functionalities without departing from embodiments disclosed herein. For additional information regarding the supply recommendation engine (110) refer to FIG. 1B.

Although the system of FIG. 1A is shown as having a certain number of components (e.g., 100, 110), in other embodiments disclosed herein, the system may have more or fewer components. For example, the functionality of each component described above may be split across components or combined into a single component. Further still, each component may be utilized multiple times to carry out an iterative operation.

FIG. 1B shows a diagram of a supply recommendation engine (110) in accordance with one or more embodiments disclosed herein. The supply recommendation engine (110) may be an embodiment of the supply recommendation engine (110, FIG. 1A) discussed above. As discussed above, the supply recommendation engine (110) may include the functionality to perform supply recommendation services. To perform the aforementioned services, the supply recommendation engine (110) may include a supply recommendation engine controller (112) and storage (114). The supply recommendation engine (110) may include other, additional, and/or fewer components without departing from embodiments disclosed herein. Each of the aforementioned components of the supply recommendation engine (110) is discussed below.

In one or more embodiments disclosed herein, the supply recommendation engine controller (112) may be implemented as a physical device. The physical device may include circuitry. The physical device may be, for example, a field-programmable gate array, application specific integrated circuit, programmable processor, microcontroller, digital signal processor, or other hardware processor. The physical device may be configured to provide the functionality of the supply recommendation engine controller (112) described throughout this Detailed Description.

In one or more embodiments disclosed herein, the supply recommendation engine controller (112) is implemented as computer instructions, e.g., computer code, stored on a storage (e.g., 106) that when executed by a processor of the supply recommendation engine (110) causes the supply recommendation engine (110) to provide the functionality of the supply recommendation engine controller (112) described throughout this Detailed Description.

In one or more embodiments, the supply recommendation engine controller (112) may include the functionality to perform the aforementioned supply recommendation services of the supply recommendation engine (110). To perform the supply recommendation services, the supply recommendation engine controller (112) may obtain requests and information from the client (100, FIG. 1A), and send information and requests to the client or a user. The supply recommendation engine controller may perform all, or a portion, of the methods discussed in FIGS. 2A-2B. For additional information regarding the functionality of the supply recommendation engine controller (112), refer to FIGS. 2A-2B.

In one or more embodiments, the storage (114) may be implemented using one or more volatile or non-volatile storages or any combination thereof. The storage (114) may include the functionality to, or otherwise be configured to, store and provide all, or portions, of information that may be used by the supply recommendation engine controller (112) and/or a user. The information stored in the storage (114) may include a part information repository (116), a constraint information repository (118), and a recommendation repository (120). The storage may include other and/or additional information without departing from embodiments disclosed herein. Each of the aforementioned types of information is discussed below.

In one or more embodiments, the part information repository (116) may refer to one or more data structures that include part information. The part information repository (116) may include one or more part entries. Each part entry may be associated with a particular part type (also referred to herein as a common functional group (CFG)). For example, the part information repository may include an solid state drive (SSD) part entry for SSDs, a hard disk drive (HDD) part entry for HDDs, a central processing unit (CPU) part entry for CPUs, a liquid crystal (LCD) part entry for LCDs, etc. Each part entry may include part information associated with the corresponding part type or CFG (e.g., SSD part entry may include SSD information, HDD part entry may include HDD information, etc.). The part information included in each part entry may include a list of supplier identifiers associated with suppliers from which the parts may be ordered. A supplier identifier may refer to a unique combination of bits and/or alphanumeric characters that are associated with and specify a particular supplier.

Each supplier identifier may be further associated with a quantity of the part that the supplier has available to purchase. The quantity may be broken down to include the quantity of one or more form factors of the part offered by the supplier. A form factor may refer to a particular form of the part that has certain set of physical characteristics (e.g., dimensions, color, etc.), capacities (e.g., memory capacity, storage capacity, etc.), and/or capabilities (e.g., IOPS, read speed, write speed, cache (for a CPU), clock rate (for a CPU), instructions per second (for a CPU), etc.) of a part. As a simple example, an SSD supplier may include two different form factors of SSDs. The first form factor may include mSATA SSDs, 250 GB capacity, and/or up to 4000 MB/s sequential read speed, and the second form factor may include M.2 SSDs, 1 TB capacity, and/or up to 560 MB/s sequential read speed. Each supplier identifier may also be associated with a price per unit. The price per unit may refer to the monetary value associated with a single unit of the part offered by the supplier. The supplier identifier may be associated with multiple price per units, one associated with each form factor offered by the supplier. The part information may include other and/or additional information associated with suppliers and their corresponding parts without departing from embodiments disclosed herein.

In one or more embodiments, the part information may be generated by and/or obtained from the client (100) and/or third party entities (not shown in FIG. 1A) directly associated with suppliers. In one or more embodiments, the supply recommendation engine controller (112) may use the part information in the part information repository (116) to generate recommendations (discussed below) for each part type or CFG. The part information repository (114) may include other and/or additional information and may be used for other and/or additional purposes without departing from embodiments disclosed herein.

In one or more embodiments, the constraint information repository (110) may refer to one or more data structures that includes one or more constraint configurations. A constraint configuration may include the following constraints: (i) long term agreements (LTAs), (ii) total addressable market (TAM) shares, (iii) form factor shares, and (iv) demand. A constraint configuration may include any combination of the aforementioned constraints without departing from embodiments disclosed herein. The constraint configurations may be associated with a particular part or CFG (e.g., SSDs, HDDs, CPUs, etc.). The constraint configurations may include other and/or additional constraints without departing from embodiments disclosed herein. Each of the aforementioned constraints is discussed below.

In one or more embodiments disclosed herein, the total number of parts being procured from a supplier must satisfy the LTA associated with a particular supplier. An LTA, or a long term agreement, may specify, directly or indirectly, a minimum quantity of parts which a user has agreed to purchase from a supplier in a particular time period (e.g., a quarter of a year). For example, a user may have an agreement with a supplier to procure 100 petabytes of SSDs from the supplier in the next quarter. As a result, the supply recommendation engine controller (112) may generate recommendations that include at least 100 petabytes of SSDs from the supplier in the next quarter. As another example, the user may have an LTA with a supplier to order 50% of users HDDs from the supplier. As yet another example, the user may have an LTA with a supplier to order 2000 CPUs from the supplier. The LTA may be a hard constraint, meaning that the supply recommendation engine controller may not adjust the LTA during recommendation generation. In other words, the LTA may be a set constraint that is not associated with a range. The LTA may include other and/or additional information without departing from embodiments disclosed herein.

In one or more embodiments disclosed herein, for every CFG, the TAM share specifies a proportion of parts allocated to each supplier within a pre-defined range that includes and upper limit and a lower limit. There may be one pair of constraints for each possible CFG and supplier combination (e.g., an upper limit and a lower limit). The TAM share constraint may mitigate the risk of a supplier growing unhappy and refusing deliver the corresponding ordered part quantity. As a result, the TAM share constraint may effectively maintains business continuity between suppliers. Even if it is cost effective to order all parts from the lowest cost supplier, this may not be a recommended practice as it may soil business relations with other suppliers. The TAM share may include other and/or additional information without departing from embodiments disclosed herein.

For example, if it is possible to procure parts in the SSD CFG from a first supplier, a second supplier, and a third supplier, even if the first supplier has cheapest price per unit, the TAM share constraint may force the supply recommendation engine from recommending to buy all SSDs from that supplier. As briefly mentioned above, there may be an upper limit on the TAM share for CFG that can be allocated to each supplier. Similarly, there may also be a TAM share lower limit on the TAM share associated with each supplier. As a result, every supplier may be recommended to receive some orders, which may help maintain good relationships with suppliers.

In one or more embodiments, a form factor may refer to the form factor discussed above. A single supplier may have parts associated with a CFG associated with one or more different form factors. A procurement strategy may include maintaining a ratio between form factors. In one or more embodiments, the form factor share may specify a ratio of form factors to adhere to during supply recommendations. In one embodiment, each form factor may include an upper share limit and a lower share limit. As a simple example, a first form factor may be given a form factor share that ranges between 25% and 35% of the parts while a second form factor may therefore be given a form factor share that ranges from 75% and 65% of the parts. In another embodiment, each form factor may have a single hard set share. As a simple example, a first form factor may be given a form factor share of 25% while a second form factor may therefore be given a form factor share of 75% of the parts. The form factor include other and/or additional information without departing from embodiments disclosed herein.

In one or more embodiments disclosed herein, each recommended CFG order quantity across all suppliers may satisfy a required demand range for that CFG. The demand range bounds may derived from the following three quantities: (i) a CFG demand forecast for an incoming time period (e.g., next quarter of the year) associated with the supply recommendations (e.g., the projected quantity of parts for the time period for which supply recommendations are being generated), (ii) an end of current time period inventory forecast for the CFG (e.g., the amount of parts of the CFG forecasted to be in the inventory at the end of the current time period), and (iii) surplus inventory of the parts for the CFG at end of the time period that is required to be able to maintain days sales of inventory (DSI) levels. DSI may refer to the number of days of supply of the CFG that should be available, so if DSI to be maintained at the end time period is 20, the CFG inventory should have 20 days of additional CFG supply after satisfying all demand for that time period. The surplus inventory may be calculated as mean daily demand forecast from the future time period (e.g., the time period that follows the incoming time period) times the DSI. For this constraint we may use a DSI range set by a user. The demand constraint may include other and/or additional information without departing from embodiments disclosed herein. The upper bound for the demand constraint may be the CFG demand forecast subtracted by the end of quarter inventory forecast then added to the surplus inventory at end of quarter using a DSI upper bound. The lower bound for demand constraint may be the CFG demand forecast subtracted by the end of quarter inventory forecast then added to the surplus inventory at end of quarter using a DSI lower bound. The demand constraint may include other and/or additional information without departing from embodiments disclosed herein.

The constraint configurations may be configured by a user. The user may submit one or more constraint configurations for each recommendation request for each part type or CFG. The constraint configurations may be generated by the user and the supply recommendation engine controller (112) using ranges and limits set by the user and calculations and forecasts generated and/or obtained by the supply recommendation engine controller (112). The forecasts mentioned above may be obtained from the client (100) or other third party entities not shown in FIG. 1A. The constraint configurations may be used by the supply recommendation engine controller (112) to generate recommendations (discussed below). The constraint information repository (118) may include other and/or additional information or be used for other and/or additional purposes without departing from embodiments disclosed herein.

In one or more embodiments, the recommendation repository (120) may refer to one or more data structures that include recommendations generated by the supply recommendation engine controller (112). Each recommendation may be associated with a CFG, a constraint configuration, and a time period. Each recommendation may include a quantity of parts for the CFG and/or the percentage of the demand for the CFG recommended by the supply recommendation engine controller (112) to order from each supplier of that CFG. The recommendation may also include the total summed price of the orders in the recommendation. The recommendations may include the quantity of form factors ordered from each supplier. The recommendations may further include price per unit associated with the suppliers and/or each form factor. The recommendations may also include the constraint configuration used to generate the recommendation. The constraint configuration may refer to the final values used for each constraint and/or the ranges of each constraint included in the constraint configuration. The time period may refer to a future period in time for which the recommendation is associated. The period of time may refer to any future period of time (e.g., the next week, the next month, the next quarter, the next year, etc.) without departing from embodiments disclosed herein. The recommendations may include other and/or additional information without departing from embodiments disclosed herein. The recommendations may be used by users to order parts or by the supply recommendation engine controller (112) to perform supply actions. The recommendation repository (120) may include other and/or additional information, or be used for other and/or additional purposes without departing from embodiments disclosed herein.

While the data structures (e.g., 116, 118, 120) and other data structures mentioned in this Detailed Description are illustrated/discussed as separate data structures and have been discussed as including a limited amount of specific information, any of the aforementioned data structures may be divided into any number of data structures, combined with any number of other data structures, and may include additional, less, and/or different information without departing from embodiments disclosed herein. Additionally, while illustrated as being stored in the storage (114), any of the aforementioned data structures may be stored in different locations (e.g., in storage of other computing devices) and/or spanned across any number of computing devices without departing from embodiments disclosed herein. The data structures discussed in this Detailed Description may be implemented using, for example, file systems, lists, linked lists, tables, unstructured data, databases, etc.

FIG. 2A shows a flowchart of a method for performing supply recommendation services in accordance with one or more embodiments disclosed herein. The method shown in FIG. 2A may be performed by, for example, a supply recommendation engine (e.g., 110, FIG. 1A). Other components of the system in FIGS. 1A-1B may perform all, or a portion, of the method of FIG. 2A without departing from the scope of the embodiments described herein. While FIG. 2A is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 200, a supply recommendation generation event is identified. In one or more embodiments, the supply recommendation engine may obtain a request to generate a recommendation from a user. The user may submit the request using any appropriate method for submitting a request without departing from embodiments disclosed herein. In one embodiment, the user may submit the request directly to the supply recommendation via a user interface (e.g., a graphical user interface (GUI), a command-line interface, etc.). In another embodiment, the user may submit the request indirectly through the client (100) and a network (e.g., Internet) via a web page interface. The request may specify the CFG and the time period for which the recommendation is to be generated. The request may further include one or more constraint configurations. The request may include other and/or additional information associated with backup generation without departing from embodiments disclosed herein.

In one or more embodiments, the supply recommendation engine may generate recommendations based on a recommendation schedule. The recommendation schedule may be a data structure that specifies points in time to generate recommendations for each CFG. The recommendation schedule may be generated by the user and provided to the supply recommendation engine, which may store it in storage (e.g, 114, FIG. 1B) and monitor the recommendation schedule to identify points in time specified by the recommendation schedule.

In one or more embodiments, the supply recommendation engine may identify the receipt of the request or the occurrence of a point in time specified by the recommendation schedule as the supply recommendation generation event. The supply recommendation generation event may be identified via other and/or additional methods without departing from embodiments disclosed herein.

In Step 202, part information associated with the supply recommendation generation event is obtained. In one embodiment, as discussed above, the storage of the supply recommendation engine may include a part information repository. The part information repository may include a part entry associated with the CFG corresponding to the supply recommendation generation request. The supply recommendation engine controller may obtain the part information (or a copy thereof) associated with the CFG from the part entry in the part information repository.

In another embodiment, if the part information repository does not include a part information entry associated with the CFG or the part entry includes outdated part information (e.g., older than a part information age threshold), then the supply recommendation engine may send a request to the client or one or more third party entities for part information associated the CFG. In response to obtaining the request, the client and/or the one or more third party entities may provide all or a portion of the part information to the supply recommendation engine. The supply recommendation engine may store a copy of the part information in a part entry of the part information repository.

The part information associated with the supply recommendation generation event may be obtained via other and/or additional methods without departing from embodiments disclosed herein.

In Step 204, a constraint configuration associated with the part information is obtained. In one or more embodiments, as discussed above, the user may submit a request in Step 200. The request may include one or more constraint configurations. The supply recommendation engine may parse the request to obtain the constraint configuration.

In another embodiment, the supply recommendation engine may prompt the user to provide a constraint configuration through a user interface. The user interface may include a GUI, a CLI, or a web page interface. The user interface may include other types of user interfaces without departing from embodiments disclosed herein. Along with the prompt, the user interface may include the CFG and all, or a portion of, the part information associated with the CFG such that the CFG and the part information may be comprehensively viewed by the user. Additionally, the user may be able to manually change part information using the user interface to fix errors, update based on new part information, etc. In response to the prompt, the user may input a constraint configuration through the user interface to the supply recommendation engine through the user interface. A constraint configuration associated with the part information may be obtained via other and/or additional methods without departing from embodiments disclosed herein.

In Step 206, a recommendation is generated based on the constraint configuration and the part information. In one or more embodiments, the supply recommendation engine generates a recommendation based on the constraint configuration and the part information via the method of FIG. 2B. For additional information regarding recommendation generation, refer to FIG. 2B.

In Step 208, the recommendation is provided to a user. In one or more embodiments, the supply recommendation engine may provide the recommendation to the user through a user interface. As discussed above, The user interface may include a GUI, a CLI, or a web page interface. The supply recommendation engine may populate the user interface with the recommendation. The supply recommendation engine may include all of the information associated with the recommendation as discussed above in FIG. 1B. In addition to the recommendation, the user interface may include the CFG and all, or a portion, of the part information. The user interface may include other and/or additional information associated with the recommendation without departing from embodiments disclosed herein. As a result, the user may have a comprehensive view of the recommendation, and the information (e.g., constraint configuration and part information) used to generate the recommendation. The recommendation may be provided to the user via other and/or additional methods without departing from embodiments disclosed herein.

In Step 210, a determination is made as to whether there is an additional constraint configuration. In one or more embodiments, as discussed above, the user may submit a request in Step 200. The request may include one or more constraint configurations. The supply recommendation engine may parse the request to check whether an additional constraint configuration is included in the request. The supply recommendation engine may tag or otherwise mark or denote constraint configurations that have already been used to generate recommendations. In one or more embodiments disclosed herein, if the supply recommendation engine identifies an additional constraint configuration in the request, then the supply recommendation engine may determine that there is an additional constraint configuration. In one or more embodiments disclosed herein, if the supply recommendation engine does not identify an additional constraint configuration in the request, then the supply recommendation engine may determine that there is not an additional constraint configuration.

In another embodiment, the supply recommendation engine may prompt the user to provide an additional constraint configuration through a user interface. The user interface may include a GUI, a CLI, or a web page interface. The user interface may include other types of user interfaces without departing from embodiments disclosed herein. Along with the prompt, the user interface may include the CFG, all, or a portion of, the part information associated with the CFG, and previously generated recommendations associated with the CFG and the time period. As a result, the CFG, part information, previously generated recommendation, and previously used constraint configurations may be comprehensively viewed by the user. The user may determine whether to submit an additional constraint configuration to generate another recommendation based on the comprehensive view provided by the user interface. Additionally, the user may be able to manually change part information using the user interface to fix errors, update based on new part information, etc. In response to the prompt, user may to reject or accept the prompt to provide an additional constraint configuration (e.g., by clicking one or more buttons, or entering a command) through the user interface. In one or more embodiments disclosed herein, if the user accepts the prompt to provide an additional constraint configuration, then the supply recommendation engine may determine that there is an additional constraint configuration. In one or more embodiments disclosed herein, if the user rejects the prompt to provide an additional constraint configuration, then the supply recommendation engine may determine that there is not an additional constraint configuration.

The determination as to whether there is an additional constraint configuration may be made via other and/or additional methods without departing from embodiments disclosed herein. In one or more embodiments disclosed herein, if it is determined that there is an additional constraint configuration, then the method proceeds to Step 214. In one or more embodiments disclosed herein, if it is determined that there is not an additional constraint configuration, then the method proceeds to Step 212.

In Step 212, supply actions are performed based on the recommendation(s). In one or more embodiments, the supply actions may include any action based on the one or more recommendations without departing from embodiments disclosed herein. The supply actions may include: (i) prompting the user to select a recommendation, (ii) sending verification requests to third party entities to verify supplier part availabilities, (iii) initiating generation of purchase orders for parts based on a recommendation, (iv) checking for and/or request new and/or additional part information and repeat recommendation generation using new part information, (v) flagging an invalid constraint configuration, and (vi) terminating the supply recommendation generation services. The supply actions may include any combination of the aforementioned actions without departing from embodiments disclosed herein. The supply actions may include other and/or additional actions without departing from embodiments disclosed herein. The supply actions may be performed based on the recommendations via other and/or additional methods without departing from embodiments disclosed herein.

In one or more embodiments disclosed herein, the method ends following Step 212.

In Step 214, an additional constraint configuration is obtained. In one or more embodiments, as discussed above, the user may submit a request in Step 200. The request may include one or more constraint configurations. The supply recommendation engine may parse the request to obtain the additional constraint configuration. The supply recommendation engine may tag or otherwise denote previously obtained constraint configurations to avoid obtaining previously obtained constraint configurations.

In another embodiment, the supply recommendation engine may prompt the user to provide an additional constraint configuration through a user interface. The user interface may include a GUI, a CLI, or a web page interface. The user interface may include other types of user interfaces without departing from embodiments disclosed herein. Along with the prompt, the user interface may include the CFG, all, or a portion of, the part information associated with the CFG, and previously generated recommendations and corresponding constraint configurations. As a result, the CFG, part information, previously generated recommendation, and previously used constraint configurations may be comprehensively viewed by the user. The user may submit an additional constraint configuration to generate another recommendation based on the comprehensive view provided by the user interface. Additionally, the user may be able to manually change part information using the user interface to fix errors, update based on new part information, etc. In response to the prompt, the user may input an additional constraint configuration through the user interface to the supply recommendation engine through the user interface. An additional constraint configuration may be obtained via other and/or additional methods without departing from embodiments disclosed herein.

In or more embodiments disclosed herein, the method proceeds to Step 206 following Step 214.

FIG. 2B shows a flowchart of a method for generating recommendations in accordance with one or more embodiments disclosed herein. The method shown in FIG. 2B may be performed by, for example, a supply recommendation engine (e.g., 110, FIG. 1A). Other components of the system in FIGS. 1A-1B may perform all, or a portion, of the method of FIG. 2B without departing from the scope of the embodiments described herein. While FIG. 2B is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 220, a determination is made as to whether there is a constraint conflict. In one or more embodiments, the supply recommendation engine applies linear optimization model to the set constraints within a constraint configuration and the part information to determine whether the initial constraint configuration is feasible. In one or more embodiments, the constraints as set in the constraint configuration may conflict with each other such that generating a recommendation based on the constraints is infeasible. In one or more embodiments, if the linear optimization model cannot generate a recommendation based on the set constraints, then the supply recommendation engine may determine that there is a constraint conflict. In one or more embodiments, if the linear optimization model can generate a recommendation based on the set constraints, then the supply recommendation engine may determine that there is not a constraint conflict. The determination as to whether there is a constraint conflict may be made via other and/or additional methods without departing from embodiments disclosed herein.

In one or more embodiments disclosed herein, if it is determined that there is a constraint conflict, then the method proceeds to Step 222. In one or more embodiments disclosed herein, if it is determined that there is not a constraint conflict, then the method proceeds to Step 224.

In Step 222, a soft constraint is adjusted. In one or more embodiments, the supply recommendation engine may incrementally adjust a soft constraint. For the initial performance of Steps 222, the soft constraints are adjusted from their initial values. The initial value of each soft constraint may be set by the user (e.g., the lowest value in the range of values). As used herein, a soft constraint refers to a constraint associated with a range inside which the constraint value may be incrementally increased or decreased to avoid constraint conflicts. The soft constraints may include demand, TAM share, and form factor share. The supply recommendation engine may be configured by a user to start with the lower range values for the soft constraints as set constraints and then incrementally adjust one soft constraint within the constraint configuration. The supply recommendation engine may adjust the soft constraint by a step value. The step value may be the same or different for each soft constraint. The soft constraint may be adjusted via other and/or additional methods without departing from embodiments disclosed herein.

In one or more embodiments disclosed herein, the method proceeds to Step 220 following Step 222. In one or more embodiments, Steps 220 and 222 may be repeated until a feasibility region is found (e.g., where there is not constraint conflict) or all possible combinations of soft constraints are tested. In one or more embodiments, if all possible soft constraint combinations are tested without finding a feasible combination of constraints, the supply recommendation engine may flag the constraint configuration as an infeasible constraint configuration, notify the user, and wait for another constraint configuration to restart the method of FIG. 2B.

In Step 224, the constraints are set. In one or more embodiments, after finding a feasibility region given a set of constraints, the supply recommendation engine may set the constraints such that the constraints are as close to the initial constraint values as possible. The constraints may be set via other and/or additional methods without departing from embodiments disclosed herein.

In Step 226, a recommendation is generated based on the part information and the set constraints. In one or more embodiments, the supply recommendation engine applies linear optimization model to the set constraints within a constraint configuration and the part information to generate a recommendation. The linear optimization model may include any appropriate type of linear optimization model (e.g., a mixed integer linear programming model) generated using any appropriate modeling languages and/or techniques (e.g., Pyomo, PuLP, SciPy, OR-tools, etc.) without departing from embodiments disclosed herein. The linear optimization model may be configured to generate a recommendation for part order allocations from each supplier at the lowest total cost while satisfying the set constraints. The recommendation may be generated based on the part information and the set constraints via other and/or additional methods without departing from embodiments disclosed herein.

In one or more embodiments disclosed herein, the method ends following Step 226.

As discussed above, embodiments of the invention may be implemented using computing devices. FIG. 3 shows a diagram of a computing device in accordance with one or more embodiments of the invention. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computing device (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing devices exist, and the aforementioned input and output device(s) may take other forms.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

As used herein, an entity that is programmed to, or configured to, perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for generating supply recommendations, comprising:
identifying, by a supply recommendation engine, a recommendation generation event associated with a part;
in response to identifying the recommendation generation event:
obtaining part information associated with the recommendation generation event;
obtaining a first constraint configuration;
generating a first recommendation based on the first constraint configuration and the part information;
obtaining a second constraint configuration; and
in response to obtaining the second constraint configuration;
generating a second recommendation based on the second constraint configuration and the part information; and
performing supply actions based on the first optimization recommendations and the second optimization recommendations.

2. The method of claim 1, wherein:
the first recommendation comprises:
suppliers;
first part quantities associated with each supplier of the suppliers; and
first costs associated with each first part quantity of the first part quantities; and
the second recommendation comprises:
the suppliers;
second part quantities associated with each supplier of the suppliers; and
second costs associated with each second part quantity of the second part quantities.

3. The method of claim 1, wherein the first constraint configuration comprises at least one hard constraint and at least one soft constraint.

4. The method of claim 3, wherein the at least one hard constraint comprises long term agreements associated with suppliers specifying minimum quantities of parts required to purchase from the suppliers.

5. The method of claim 3, wherein the at least one soft constraint comprises one selected from a group consisting of:
total addressable market (TAM) share ranges associated with suppliers;
form factor share ranges associated with the suppliers; and
a demand range associated with the part.

6. The method of claim 3, wherein the at least one soft constraint is associated with an upper limit range and a lower limit range.

7. The method of claim 6, wherein generating the first recommendation based on the first constraint configuration and the part information comprises:
making a determination that there is a constraint conflict; and
in response to the determination:
adjusting the at least one soft constraint based on the lower limit range to obtain adjusted constraints.

8. The method of claim 6, wherein generating the first recommendation based on the first constraint configuration and the part information comprises:
making a determination that there is a constraint conflict; and
in response to the determination:
adjusting the at least one soft constraint based on the upper limit range to obtain adjusted constraints.

9. The method of claim 8, wherein generating the first recommendation based on the first constraint configuration and the part information comprises generating the first recommendation by applying a linear optimization model to the adjusted constraints and the part information.

10. The method of claim 1, wherein the supply actions comprise sending a part availability verification request.

11. A non-transitory computer readable medium comprising computer readable program code, which when executed by a computer processor enables the computer processor to perform a method for generating supply recommendations, the method comprising:
identifying, by a supply recommendation engine, a recommendation generation event associated with a part;
in response to identifying the recommendation generation event:
obtaining part information associated with the recommendation generation event;
obtaining a first constraint configuration;
generating a first recommendation based on the first constraint configuration and the part information;
obtaining a second constraint configuration; and
in response to obtaining the second constraint configuration;
generating a second recommendation based on the second constraint configuration and the part information; and
performing supply actions based on the first optimization recommendations and the second optimization recommendations.

12. The non-transitory computer readable medium of claim 11, wherein:
the first recommendation comprises:
suppliers;
first part quantities associated with each supplier of the suppliers; and
first costs associated with each first part quantity of the first part quantities; and
the second recommendation comprises:
the suppliers;
second part quantities associated with each supplier of the suppliers; and
second costs associated with each second part quantity of the second part quantities.

13. The non-transitory computer readable medium of claim 11, wherein the first constraint configuration comprises at least one hard constraint and at least one soft constraint.

14. The non-transitory computer readable medium of claim 13, wherein the at least one hard constraint comprises long term agreements associated with suppliers specifying minimum quantities of parts required to purchase from the suppliers.

15. The non-transitory computer readable medium of claim 13, wherein the at least one soft constraint comprises one selected from a group consisting of:
total addressable market (TAM) share ranges associated with suppliers;
form factor share ranges associated with the suppliers; and
a demand range associated with the part.

16. A system for generating supply recommendations, comprising:
a storage for storing recommendations; and
a supply recommendation engine, comprising a processor and memory, programmed to:
identify a recommendation generation event associated with a part;
in response to identifying the recommendation generation event:
obtain part information associated with the recommendation generation event;
obtain a first constraint configuration;
generate a first recommendation based on the first constraint configuration and the part information;
obtain a second constraint configuration; and
in response to obtaining the second constraint configuration;
generate a second recommendation based on the second constraint configuration and the part information; and
perform supply actions based on the first optimization recommendations and the second optimization recommendations.

17. The system of claim 16, wherein:
the first recommendation comprises:
suppliers;
first part quantities associated with each supplier of the suppliers; and
first costs associated with each first part quantity of the first part quantities; and
the second recommendation comprises:
the suppliers;
second part quantities associated with each supplier of the suppliers; and
second costs associated with each second part quantity of the second part quantities.

18. The system of claim 16, wherein the first constraint configuration comprises at least one hard constraint and at least one soft constraint.

19. The system of claim 18, wherein the at least one hard constraint comprises long term agreements associated with suppliers specifying minimum quantities of parts required to purchase from the suppliers.

20. The system of claim 18, wherein the at least one soft constraint comprises one selected from a group consisting of:
total addressable market (TAM) share ranges associated with suppliers;
form factor share ranges associated with the suppliers; and
a demand range associated with the part.
